(19) United States
(12) Patent Application Publication
(10) Pub. No.: US 2014/0115672 A1
(43) Pub. Date: Apr. 24, 2014

(54) Storing and Accessing Licensing Information in Operating System-Independent Storage

(71) Applicants: Roger Wood, Portland, OR (US); Jens Rebaum, Portland, OR (US)

(72) Inventors: Roger Wood, Portland, OR (US); Jens Rebaum, Portland, OR (US)

(21) Appl. No.: 13/654,568

(22) Filed: Oct. 18, 2012

(51) Int. Cl. G06F 21/00

(52) U.S. Cl. 726/5; 726/3

(57) ABSTRACT

Licensing information that guides the operation of a software application may be stored in operating system-independent storage of a device on which the software application is installed. The operating system-independent storage may be independent of the device's file system and may include storage that is implemented as part of a chipset of the device. The licensing information may be written to the device's operating system-independent storage by a remote device over a communications network regardless of the state of the device. The licensing information may be subsequently accessed by the software application to determine whether functionality requested by a user of the application is supported by the licensing information.

### TECHNICAL FIELD

This disclosure relates generally to the storage and utilization of licensing information that guides the operation of a software application. More particularly, but not by way of limitation, this disclosure relates to a technique to store licensing information in a secure location on a device on which the software application is installed.

### BACKGROUND ART

As is known by those skilled in the art, software licensing and activation operations rely on the secure storage of licensing information that is used to govern the operation of a software application. Existing licensing schemes store licensing information in addressable hard disk space managed by a computer's operating system. Such licensing information may include the level of a software application that a user purchased (e.g., Professional, Beginner, etc.), an expiration date for the software application, an indication that the software has been activated/registered with the application's provider, or other data that guides the application's operation. These existing techniques allow software developers to enable different functionality based on a license acquired by a user (i.e., the functionality of common program code is guided by the licensing information). However, the storage of licensing information within addressable hard disk space subjects the licensing information to compromise and manipulation by other applications and/or users which can significantly affect the operation of the licensed software. It would be beneficial to store licensing information in a local storage location that is more secure from compromise or manipulation.

### BRIEF DESCRIPTION OF THE DRAWINGS

FIG. 1 is a block diagram that illustrates a device and a management server in accordance with one embodiment.

FIG. 2 is a flowchart that illustrates a licensing information provisioning process in accordance with one embodiment.

FIG. 3 is a flowchart that illustrates a licensing information utilization process in accordance with one embodiment.

FIG. 4 is a communication flow diagram that illustrates the exchange of information between a user device, a management server, and a software provider in accordance with one embodiment.

FIG. 5 is a block diagram of an illustrative electronic device in accordance with one embodiment.

### DESCRIPTION OF THE EMBODIMENTS

This disclosure pertains to the storage and use of licensing information in operating-system independent storage. In general, techniques are disclosed for writing licensing information to an operating system-independent storage and later accessing that storage to determine if a requested task is supported by a valid license.

In the following description, for purposes of explanation, numerous specific details are set forth in order to provide a thorough understanding of the inventive concept. As part of this description, some of this disclosure's drawings represent structures and devices in block diagram form in order to avoid obscuring embodiments of the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals will vary from one implementation to another. It will also be appreciated that such development efforts might be complex and time-consuming, but would nevertheless be a routine undertaking for those of ordinary skill in the art having the benefit of this disclosure.

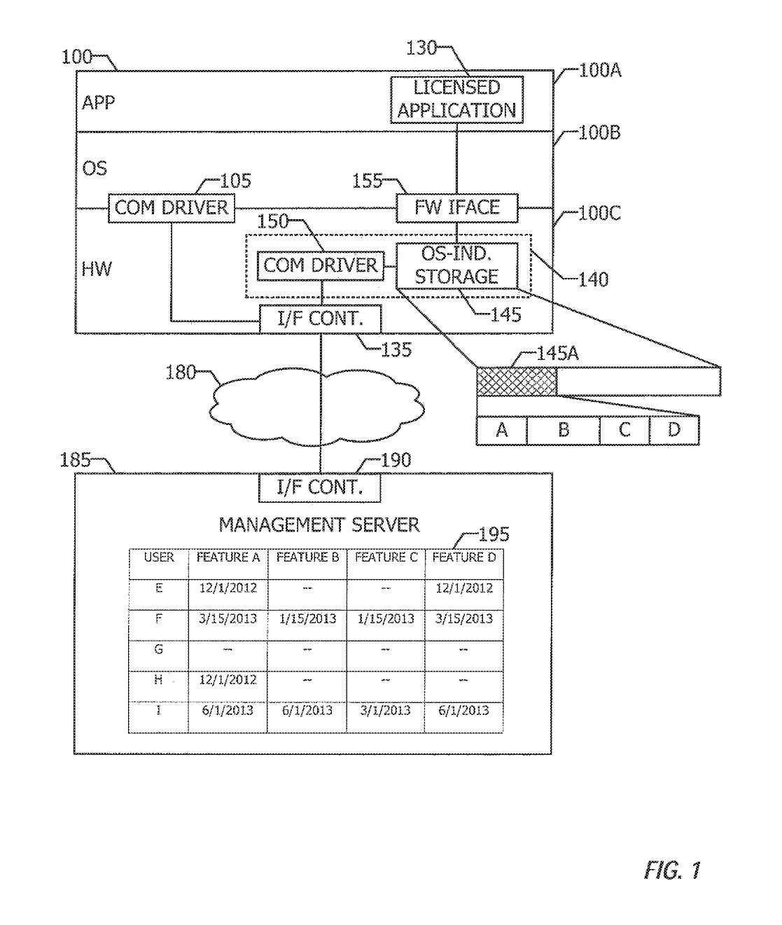

Referring to FIG. 1, device 100 includes application layer 100A, operating system layer 100B, and hardware layer 100C. Application layer 100A may include user level application software such as application 130. Application 130 may be any type of software application (e.g., word processing, financial planning, spreadsheet, antivirus, etc.) having certain features that require a license in order to function. The program code for each installation of application 130 may be the same (e.g., may include the full functionality of application 130), but certain features of application 130 may need to be “unlocked” by obtaining a license to utilize the features. As is known by those skilled in the art, device 100's operating system may reside in operating system layer 100B and may manage portions of hardware layer 100C and provide common functionality to applications in application layer 100A. Hardware layer 100C may include the physical components that form device 100. For example, hardware layer 100C may include one or more central processing units (CPUs) each having one or more cores, one or more memory devices, peripheral devices, etc. Of particular relevance to the instant disclosure, hardware layer 100C may include management firmware 140. Management firmware 140 may be located within a microcontroller in a chipset associated with a processing device of device 100 and may provide hardware-based functionality for managing device 100. Such functionality may be provided, for example, by chipsets including Intel® Active Management Technology. (INTEL is a registered trademark of Intel Corporation.)

In the illustrated embodiment, management firmware 140 includes operating system-independent storage 145. As used herein, operating system-independent storage refers to storage that is not mounted by a device's operating system. Thus, operating system-independent storage 145 is not part of device 100's file system. In one embodiment, operating system-independent storage 145 may include non-volatile storage. For example, operating system-independent storage may include flash storage. In one embodiment, operating system-independent storage 145 may be integrated within a processing device used to control device 100.

In one embodiment, operating system-independent storage 145 may be allocated such that various portions are reserved for certain applications. For example, portion 145A may be allocated to application 130. Accordingly, portion 145A may only be utilized (e.g., written to or read from) by application 130 or other applications authorized by application 130. Within allocated portion 145A, application 130 may store licensing data pertaining to various application features (e.g., features A, B, C, and D). In one embodiment, the licensing data may include a simple indication of whether a particular feature is enabled (e.g., a single bit), an expiration date for the feature, a number of seats for a seat license, etc. Accordingly, the amount of storage space dedicated to particular features may vary in size. Although portion 145A has been described in terms of licensing data associated with particular features of a single application, in another embodiment, a portion of operating system-independent storage 145 may be allocated to an application that manages licensing data on behalf of multiple additional applications.

As will be described in greater detail below, operating system-independent storage 145 may be accessible to certain applications running on device 100 via management firmware interface 155. Management firmware interface 155 may serve as a device driver that allows an application to access operating system-independent storage 145. Consequently, application software may include program code to cause the application to access operating system-independent storage 145 to determine whether certain application functionality is supported by a current license. Operating system-independent storage 145 may also be accessible to certain remote devices via communications driver 150. Communications driver 150 may interact with network interface controller 135 to facilitate communications via network 180, such as, for example, with management server 185. As will be described in greater detail below, the location of communications driver 150 within management firmware 140 may enable communications when device 100 (and thus communications driver 105) is not in an active state.

Management server 185 may have resident thereon data store 195 that associates licensing information for various features and/or applications with user information pertaining to a user associated with the license. In the illustrated embodiment, data store 195 includes expiration date licensing information for the features of application 130 for multiple users (e.g., users E, F, G, H, and I). A date entered in data store 195 may indicate the date on which a current license expires for the specified feature while an entry of “—” may indicate that no license exists for the specified feature. Expiration date licensing information may be utilized by application software (e.g., by accessing the information in operating system-independent storage 145) to determine whether certain functionality should be enabled. For example, a user may purchase a license for an application or application feature that is valid for a certain time period (e.g., one year). When a user attempts to utilize the licensed application or feature, the application software may compare the current date to the stored expiration date to determine whether the functionality is available under a current license. In this way application functionality may be enabled during the term of a license and blocked after the expiration of the license. Although FIG. 1 depicts expiration date licensing information in data store 195, it will be understood that numerous additional types of licensing information may be utilized to control the operation of software applications. For example, the licensing information may indicate features that are enabled, define a maximum data transfer rate for a particular application, define a maximum number of users of a shared resource, etc.

As will be described in greater detail below, the licensing information contained in data store 195 may be communicated by a software provider (or vendor) to management server 185 when a user purchases or upgrades a software license. The licensing information for a particular device may then be written to operating system-independent storage 145 for the device on which the software is installed via network interface controller 190 over network 180. Network 180 may take any form including, but not limited to, a local area network (LAN), a wide area network (WAN) such as the Internet or a combination of local and wide-area networks. Moreover, the network may use any desired technology (wired, wireless or a combination thereof) and protocol (e.g., transmission control protocol, TCP).

In one embodiment, management firmware 140 may be operational regardless of the operating system and power state of device 100. For example, management firmware 140 may operate on auxiliary power when device 100 is in powered-down or stand-by states. Consequently, operating system-independent storage 140 may be accessible to management server 185 via out of band communications over network 180 even when device 100 is powered down or when device 100's operating system is not active. Therefore, licensing information may be written from data store 195 to local operating system-independent storage 145 regardless of the operating state of device 100.

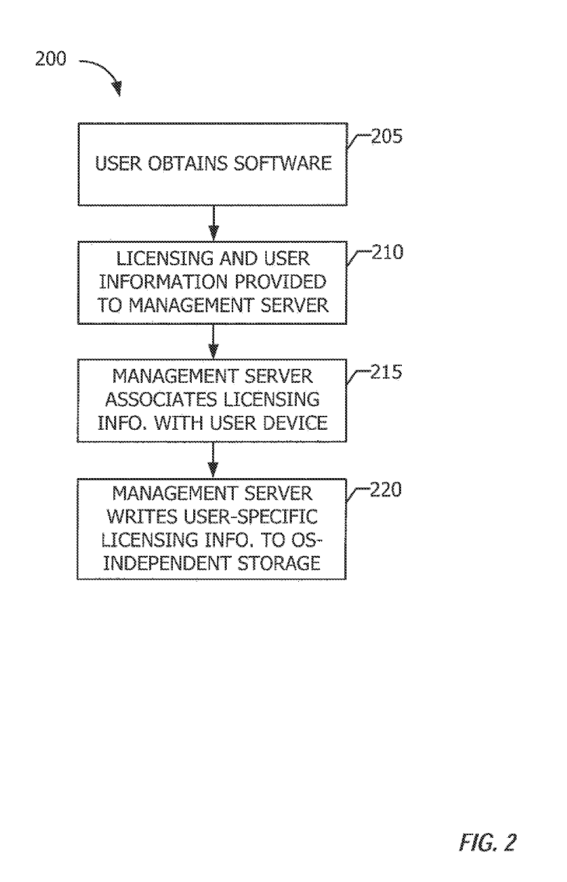

Referring to FIG. 2, license provisioning process 200 in accordance with one embodiment may begin when a user (such as a user of device 100) obtains software (block 205). As is known, software may be obtained in a variety of manners. In one embodiment, the user may obtain the software electronically, such as, for example, by downloading the software from an Internet web server provided by the software provider or a software vendor. In another embodiment, a physical copy of the software (e.g., a copy embodied on a tangible medium such as a CD-ROM, DVD, Universal Serial Bus (USB) memory device, etc.) may be obtained by the user.

The software obtained by the user may be associated with a particular license that “unlocks” certain software functionality. For example, a user purchasing a “Professional” version of software may receive a license that enables greater functionality than a license associated with a “Beginner” version of the same software. Thus, when a user obtains software, the software provider may associate information identifying the user with licensing information corresponding to the obtained software version or features. In one embodiment, if a user purchases an electronic copy of software from the software provider's website, the software provider may obtain the necessary information through the purchasing process. For example, during the purchasing process, information that identifies the user (e.g., name, credit card information, etc.) may be obtained directly by the software provider (or software vendor) and may be associated with licensing information corresponding to the purchased software. In another embodiment (such as when a physical copy of the software is obtained from an entity other than the software provider), upon installation, the software may initiate a registration process according to which user information and licensing information corresponding to the obtained software are provided to the software provider directly or through a third party (e.g., through a connection to the software provider's website). While license provisioning process 200 has thus far been described in terms of a user obtaining new software, it should be noted that the same process may apply to a user that renews or upgrades a license for existing software. That is, when a user obtains a new license for existing software, information identifying the user may be associated with the new license as described above and process 200 may continue as described below.

The associated user information and licensing information corresponding to the obtained software may be provided to a management server (block 210). In one embodiment, the user and licensing information may be provided by a software provider. For example, the software provider may obtain the user and licensing information as described above and may thereafter communicate the licensing information to a management server. In one embodiment, the management server may be controlled by the software provider. In such an embodiment, the software provider may itself manage the provision of licensing information from the management server and may itself incorporate program code in the obtained software that causes the software to retrieve licensing information from the local operating system-independent storage.

In another embodiment, the management server may be operated by a third party. In such an embodiment, the third party may manage the provision of licensing information from the management server and may provide a software library that enables software providers to utilize licensing information stored in local operating system-independent storage. Thus, a software provider may simply provide current user/licensing information to the third party and may implement the third party-provided library in the obtained software such that licensing information may be obtained from local operating system-independent storage using the third party interface.

In yet another embodiment, the management server may be operated by the purchaser of the software. For example, a purchaser of a large number of software application licenses (e.g., a corporate user) may maintain its own management server on a local area network that obtains updated user/licensing information (e.g., from the software provider) and pushes the licensing information to local operating system-independent storage for users of the software.

After the user and licensing information have been provided to the management server, the management server may associate the licensing information with the device on which the obtained software is installed (block 215). In one embodiment, the device on which the obtained software is installed may be identifiable directly from the user/licensing information maintained by the management server. For example, in the corporate context described above, user information may include a static Internet protocol (IP) address for a device on the same local area network as the management server. Therefore, the device may be identifiable based on information stored on the management server. In another embodiment, the device on which the obtained software is installed may not be identifiable based solely on the user/licensing information provided to the management server. For example, a personal user may install the obtained software on a device having a dynamic IP address that communicates with the management server via an Internet connection. In such an embodiment, the device may need to initiate communication with the management server (e.g., via an Internet connection to the management server) in order to allow the licensing information to be associated with the device. For example, the obtained software may cause the device to periodically contact the management server and to present identifying information (e.g., a user name or account access credentials) that enables the management server to match the device to the user information and, therefore, the associated licensing information. It should be noted that the program code to cause the device to contact the management server may be stored within the management firmware described above. Therefore, the device may contact the management server regardless of the device's operating state (e.g., powered down or inactive operating system).

After the management server associates licensing information with a particular device, the management server may write the licensing information to local operating system-independent storage on the device (block 220). In one embodiment, write access to the operating system-independent storage may require write credentials. In such an embodiment, a copy of the write credentials may be stored within the operating system-independent storage and write access may be granted only to an entity that presents matching credentials. For example, a software provider that controls its own management server may obtain a write certificate from a third party certificate provider and may include a copy of the write certificate in software that the provider supplies. A copy of the write certificate may be stored in the operating system-independent storage for comparison to the write certificate presented by the management server upon an attempt by the management server to write to the operating system-independent storage. In such an embodiment, the copy of the write certificate provided with the software may be provided in an encrypted format. Similarly, if a software provider utilizes the services of a third party to provision licensing information, a copy of the third party's write certificate may be provided with copies of the software.

In one embodiment, write credentials may be valid for a single remote device. In such an embodiment, a management server may need to provide valid write credentials that match write credentials stored in the operating system-independent storage as well as self-identifying information that allows the management server to be authenticated as the entity authorized to write data based on the presented write certificate. As described above with respect to FIG. 1, communications driver 150 within management firmware 140 may enable communications with management server 185. Management firmware 140 may verify the credentials presented by the management server and, upon verification, the management server may be able to write current licensing information to local operating system-independent storage 145 regardless of the state of device 100.

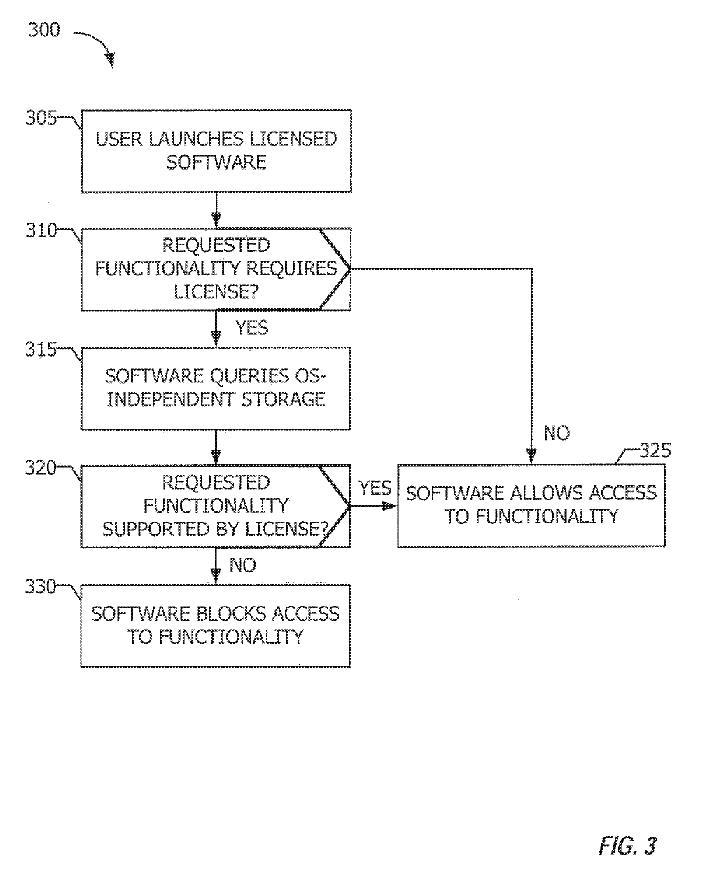

Referring to FIG. 3, license utilization process 300 in accordance with one embodiment may begin when a user utilizes software that incorporates functionality that is guided by licensing information stored in operating system-independent storage (block 305). When a user attempts to use certain functionality of the software, it may be determined whether the requested functionality requires a license (block 310). For example, certain software functionality (e.g., data transfer, number of users simultaneously accessing a database, etc.) may be controlled by licensing information while other functionality may be available without a license. It will be understood that this determination may be made within the software application itself. That is, where certain functionality requires a license, the software may include program code to cause licensing information to be retrieved before the functionality is enabled. If it is determined that the requested functionality requires a license (the “Yes” prong of block 310), the software may query local operating system-independent storage for applicable licensing information (block 315). With reference to FIG. 1, access to operating system-independent storage may be obtained via firmware interface 155. In one embodiment, firmware interface 155 may function as a hardware device driver that interfaces between applications running in application layer 100A and operating system-independent storage 145. As noted above, operating system-independent storage 145 may be allocated such that only portions that are allocated to a particular application (or a particular process) may be accessible. In one embodiment, an application may present read credentials in order to access licensing information in operating system-independent storage. Similar to the write credentials described above, read credentials presented by an application may be compared to credentials stored in operating system-independent storage (e.g., credentials created as part of the allocation of operating system-independent storage) to verify that the application is authorized to read data from the operating system-independent storage. In one embodiment, read access may also be tied to a particular process. That is, only one process executing on a processor may be capable of retrieving data from an allocated portion of operating system-independent storage. According to one embodiment of this disclosure, operating system independent storage may provide for the local storage of licensing information that is less susceptible to unauthorized access or manipulation based on the security features provided by the operating system-independent storage. Moreover, because operating system-independent storage is independent of the type of operating system in which the application is running, access to licensing information in operating system-independent storage may be uniform regardless of the operating system.

As noted above, in one embodiment, a management server that writes licensing data to operating system-independent storage may be controlled by a software provider that desires to implement the functionality of operating system-independent licensing information in software that it provides. In such an embodiment, the software provider may obtain write credentials for the management server that it controls and may obtain read credentials to allow its software to read the licensing information written to operating system-independent storage. The software provider may also implement program code in its software to access operating system-independent storage (e.g., by interfacing with firmware interface 155).

In another embodiment, as was briefly described above, a software provider desiring to utilize licensing information stored in operating system-independent storage in its software may also elect to implement this functionality via a third party. For example, rather than maintaining its own management server, managing its own read and write credentials, and implementing program code to allow its software to access operating system-independent storage, a software provider may delegate these tasks to a third party provider. In such an embodiment, the third party provider may operate a single management server to provision licensing information on behalf of multiple software applications from, possibly, multiple software vendors. In conjunction with this function, the third party may also provide a software library that allows software applications to utilize the library to access licensing information from operating system-independent storage. For example, a software library provided by the third party may include a function that causes a third party application to retrieve licensing information from operating system-independent storage on behalf of the calling application (perhaps using the third party's own read credentials). As such, a software provider may reap the benefits of improved licensing information security without participating directly in the provisioning and retrieval operations by providing licensing information to a third party and employing a third party library to access the licensing information.

After the licensing information is retrieved from the operating system-independent storage, it may be determined whether the requested software functionality is supported by the license (block 320). Determining whether the requested functionality is supported may include performing an operation utilizing the information obtained from the operating system-independent storage. That is, the retrieved information may include data that is operated on by functionality programmed into the software to guide the behavior of the software. For example, if the retrieved information is an expiration date, program code within the software may compare a current date to the retrieved date in order to determine if the license for the requested functionality has expired. Likewise, if the retrieved information includes information concerning the number of seats purchased for a group seat license, it may be determined if the number of current users of the software is less than the number of seats as set forth in the retrieved information. Additional means of controlling a software application based on the retrieved licensing information will be recognized by those of ordinary skill in the art. If it is determined that the functionality requested by a user of the software is supported by the licensing information or that the functionality does not require a license (the “Yes” and “No” prongs of blocks 320 and 310, respectively), the software may allow access to the requested functionality (block 325). If, however, the requested functionality requires a license and is not supported by the retrieved licensing information (the “No” prong of block 320), the software may block access to the functionality (block 330). If requested functionality is blocked, the software may inform the user that the requested functionality requires a license and that the required license has not been obtained, has expired, or is otherwise defective. The software may also allow the user to obtain the required license such that the functionality may be enabled.

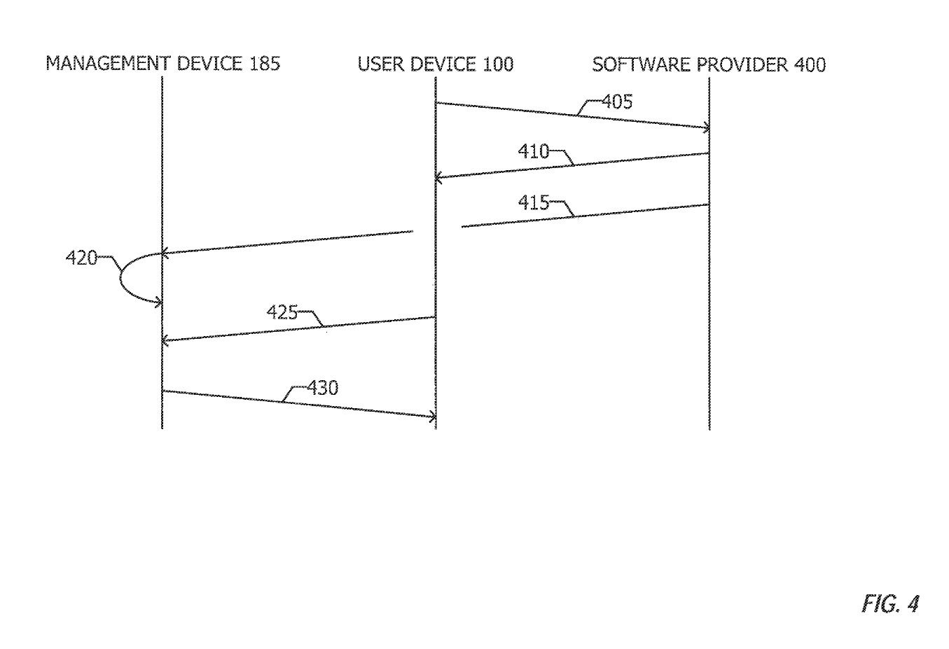

Referring to FIG. 4, a communication flow diagram illustrates the flow of information in accordance with one embodiment of license provisioning process 200. User device 100 may obtain software from software provider 400. In conjunction with device 100 obtaining software, information identifying the user of device 100 and linking the user information with licensing information associated with the obtained software (e.g., version information) may be provided to software provider 400 (405). As described above with respect to FIG. 2, user and licensing information may be provided to software provider 400 as part of the purchase of the software, as part of the registration of the software, etc. The user and licensing information may be communicated from device 100 to software provider 400 via a communications network (e.g., a connection with the software provider's web server). The user may also provide information to software provider 400 that allows licensing information to be updated in the future. For example, the user may provide credit card information and may authorize recurring credit card charges to allow the software provider to charge the credit card in order to maintain an active license for the software. In response to the user providing the necessary identifying information, software provider 400 may provide a response to user device 100 indicating that the obtained software has been licensed (410). At substantially the same time, software provider 400 may provide the associated user and licensing information to management device 185 (415). As described above, management device 185 may be controlled by software provider 185, the user of the obtained software, or a third party. In one embodiment, management device 185 may be a web server and may receive the information from software provider 400 via an Internet connection. In another embodiment, management device 185 may be a data server on the same local area network as device 100. The linked user information and licensing information may be stored in a data store on management device 185 (420).

Device 100 may thereafter contact management device 185 (e.g., via an Internet connection) to allow device 100 to be recognized as the device on which the software was installed (425). Communication 425 may include the user information provided to software provider 400 (and communicated to management device 185) or some identifying information that allows device 100 to be associated with the provided user information. For example, a user name and password, credit card information, or other identification may be provided to management device 185 such that management device 185 may associate device 100 with the prior stored user information and, therefore, the linked licensing information. In one embodiment, device 100 may also provide information identifying the device (e.g., a hardware identifier). In such an embodiment, management device 185 may update the data store that contains the licensing records to include a device identifier. Consequently, management device 185 may be capable of managing licensing information from a device perspective as well as a user perspective. For example, if a user installs software on a first device and licensing data is written to operating system-independent storage on the first device, if the user installs the software on a second device, management device 185 may either refuse to write the licensing information to the second device or may remove the licensing information from the first device prior to writing the information to the second device.

After device 100 is associated with the licensing information, the licensing information may be written from management device 185 to operating system-independent storage on device 100 for subsequent use by the software (430). As described above, the provision of licensing information from management device 185 may occur regardless of the operating state of device 100. Thus, the storage of licensing information within local operating system-independent storage in accordance with this disclosure provides secure storage of the licensing information and allows the licensing information to be updated regardless of the state of the device.

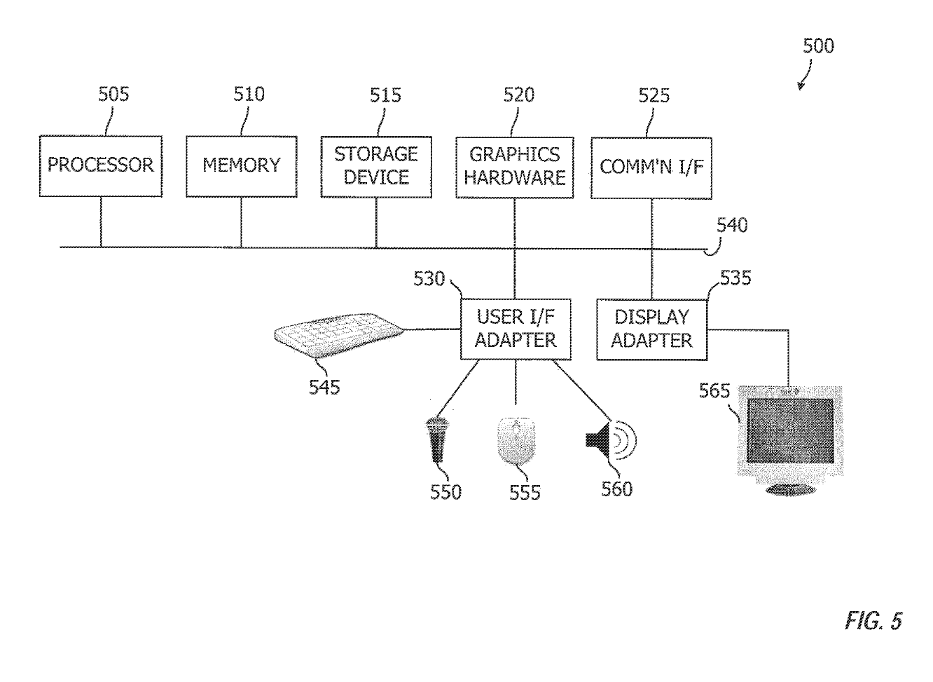

Referring to FIG. 5, representative device 500 (e.g., a general purpose desktop computer system) includes processor 505, memory 510, storage 515, graphics hardware 520, communication interface 525, user interface adapter 530 and display adapter 535—all of which may be coupled via system bus or backplane 540. Memory 510 may include one or more different types of media (typically solid-state) used by processor 505 and graphics hardware 520. For example, memory 510 may include memory cache, read-only memory (ROM), and/or random access memory (RAM). Storage 515 may store media (e.g., audio, image and video files), computer program instructions or software, preference information, device profile information, and any other suitable data. Storage 515 may include one or more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 510 and storage 515 may be used to tangibly retain computer program instructions or code organized into one or more modules and written in any desired computer programming language. When executed by processor 505 and/or graphics processor 520 such computer program code may implement one or more of the methods described herein. Communication interface 525 may be used to connect system 500 to a network. Illustrative networks include, but are not limited to: a local network such as a USB network; a business' local area network; or a wide area network such as the Internet. User interface adapter 530 may be used to connect keyboard 545, microphone 550, pointer device 555, speaker 560 and other user interface devices such as a touch-pad and/or a touch screen (not shown). Display adapter 535 may be used to connect display 565.

Processor 505 may include any programmable control device including, without limitation, one or more members from: the Intel Core®, Intel Atom®, Pentium® and Celeron® processor families. (INTEL CORE, INTEL ATOM, PENTIUM and CELERON are registered trademarks of Intel Corporation.) Processor 505 may also be implemented as a custom designed circuit that may be embodied in hardware devices such as application specific integrated circuits (ASICs) and field programmable gate arrays (FPGAs). Any of the devices described above (e.g., device 100 and management device 185) may take the form of system 500. Moreover, while system 500 has been described in terms of a general purpose desktop personal computer, the methods described herein may also be applicable to other types of devices having some or all of the components of system 500 (e.g., a personal digital assistant (PDA), personal music player, mobile telephone, notebook, laptop or server computer, etc.). Finally, system 500 may have resident thereon any desired operating system.

The following examples pertain to further embodiments. In a first embodiment, a non-transitory program storage device, readable by a processor comprises instructions stored thereon to cause the processor to receive a request to perform an action at a local device, determine that the requested action requires a license, and request data from an operating system-independent storage on the local device to determine if a valid license for the requested action exists, where the operating system-independent storage is resident in a chipset associated with the processor.

In the above example, the operating system-independent storage may include a non-volatile flash storage device. In the above example, the instructions to cause the processor to request data from an operating system-independent storage on the local device may include instructions to cause the processor to request the data through a hardware device driver. In the above example, further instructions may cause the processor to communicate with a remote device to obtain the data. In the above example, the instructions to cause the processor to communicate with a remote device to obtain the data may be executable by the processor when the local device is in a powered-down state. In the above example, the instructions to cause the processor to request data from an operating system-independent storage on the local device may include instructions to cause the processor to present read credentials. In the above example, the instructions to cause the processor to request data from an operating system-independent storage on the local device may include instructions to cause the processor to utilize a function from a third party software library. In the above example, the instructions to cause the processor to request data from an operating system-independent storage on the local device to determine if a valid license for the requested action exists may include instructions to cause the processor to perform an operation on the data. In the above example, the data may include an expiration date and the instructions to cause the processor to perform an operation on the data may include instructions to cause the processor to determine if a current date is prior to the expiration date. In the above example, further instructions may cause the processor to perform the requested action only when it is determined that the valid license for the requested action exists. In the above example, the instructions to cause the processor to request data from an operating system-independent storage on the local device may include instructions to cause the processor to request data from a portion of the operating system-independent storage that is allocated to a software application.

In another example, a method performed by a processor includes receiving, by a software application, a request to perform an action at a local device, determining, by the software application, that the requested action requires a license, and accessing, by the software application, licensing information from an operating system-independent storage on the local device to determine if the requested action should be performed, where the operating system-independent storage is resident in a chipset associated with the processor.

In the above example, the operating system-independent storage may include a non-volatile flash storage device. In the above example, the act of accessing licensing information from an operating system-independent storage may include requesting the licensing information through a hardware device driver. In the above example, the method may further include communicating with a remote device to obtain the licensing information. In the above example, the act of communicating with a remote device to obtain the licensing information may be performed when the local device is in a powered-down state. In the above example, the act of accessing licensing information from an operating system-independent storage on the local device may include presenting read credentials. In the above example, the act of accessing licensing information from an operating system-independent storage on the local device may include calling, by the software application, a function provided in a third party library. In the above example, the act of accessing licensing information from an operating system-independent storage on the local device to determine if the requested action should be performed may include performing an operation on the licensing information. In the above example, the licensing information may include an expiration date and the act of performing an operation on the licensing information may include determining if a current date is prior to the expiration date. In the above example, the method may further include performing the requested action only when it is determined that a valid license for the requested action exists. In the above example, the act of accessing licensing information from an operating system-independent storage on the local device may include accessing a portion of the operating system-independent storage that is allocated to the software application.

In another example, a device includes a memory and a processor having a storage in an associated chipset that is independent of an operating system of the device. The processor is adapted to execute program code stored in the memory to receive a request to perform an action, determine that the requested action requires a license, and request data from the operating system-independent storage to determine if a valid license for the requested action exists.

In the above example, the operating system-independent storage may include a non-volatile flash storage device. In the above example, the program code to cause the processor to request data from the operating system-independent storage may include program code to cause the processor to request the data through a hardware device driver. In the above example, further program code may cause the processor to communicate with a remote device to obtain the data. In the above example, the program code to cause the processor to communicate with a remote device to obtain the data may be executable by the processor when the device is in a powered-down state. In the above example, the program code to cause the processor to request data from the operating system-independent storage may include program code to cause the processor to present read credentials. In the above example, the program code to cause the processor to request data from the operating system-independent storage may include program code to cause the processor to utilize a function from a third party software library. In the above example, the program code to cause the processor to request data from the operating system-independent storage to determine if a valid license for the requested action exists may include program code to cause the processor to perform an operation on the data. In the above example, the data may include an expiration date and the program code to cause the processor to perform an operation on the data may include program code to cause the processor to determine if a current date is prior to the expiration date. In the above example, further program code may cause the processor to perform the requested action only when it is determined that the valid license for the requested action exists. In the above example, the program code to cause the processor to request data from the operating system-independent storage may include program code to cause the processor to request data from a portion of the operating system-independent storage that is allocated to a software application.

In yet another example, a method includes storing, by a processor, licensing information for a software application and corresponding user information in a data store, associating, by the processor, the licensing information with a device on which the software application is installed, and writing, by the processor, the licensing information to an operating system-independent storage on the device, where the operating system-independent storage is resident in a chipset associated with a processor of the device.

In the above example, the act of writing the licensing information to an operating system-independent storage on the device may include presenting write credentials to the device. In the above example, the act of writing the licensing information to an operating system-independent storage may include writing the licensing information using out of band communications over a network connection with the device when the device is in a powered down state. In the above example, the act of writing the licensing information to an operating system-independent storage may include writing the licensing information over a network connection with the device when an operating system of the device is inactive. In the above example, the act of storing licensing information for a software application and corresponding user information in a data store may include receiving the licensing information and the corresponding user information from a provider of the software application.

It is to be understood that the above description is intended to be illustrative, and not restrictive. The material has been presented to enable any person skilled in the art to make and use the inventive concepts described herein, and is provided in the context of particular embodiments, variations of which will be readily apparent to those skilled in the art (e.g., some of the disclosed embodiments may be used in combination with each other). Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a processor and comprising instructions stored thereon to cause the processor to:
receive a request to perform an action at a local device;
determine that the requested action requires a license; and
request data from an operating system-independent storage on the local device to determine if a valid license for the requested action exists, wherein the operating system-independent storage is resident in a chipset associated with the processor.

2. The non-transitory program storage device of claim 1, wherein the operating system-independent storage comprises a non-volatile flash storage device.

3. The non-transitory program storage device of claim 1, wherein the instructions to cause the processor to request data from an operating system-independent storage on the local device comprise instructions to cause the processor to request the data through a hardware device driver.

4. The non-transitory program storage device of claim 1, further comprising instructions to cause the processor to communicate with a remote device to obtain the data.

5. The non-transitory program storage device of claim 4, wherein the instructions to cause the processor to communicate with a remote device to obtain the data are executable by the processor when the local device is in a powered-down state.

6. The non-transitory program storage device of claim 1, wherein the instructions to cause the processor to request data from an operating system-independent storage on the local device comprise instructions to cause the processor to present read credentials.

7. The non-transitory program storage device of claim 1, wherein the instructions to cause the processor to request data from an operating system-independent storage on the local device comprise instructions to cause the processor to utilize a function from a third party software library.

8. The non-transitory program storage device of claim 1, wherein the instructions to cause the processor to request data from an operating system-independent storage on the local device to determine if a valid license for the requested action exists comprise instructions to cause the processor to perform an operation on the data.

9. The non-transitory program storage device of claim 8, wherein the data comprises an expiration date and wherein the instructions to cause the processor to perform an operation on the data comprise instructions to cause the processor to determine if a current date is prior to the expiration date.

10. The non-transitory program storage device of claim 1, further comprising instructions to cause the processor to perform the requested action only when it is determined that the valid license for the requested action exists.

11. A method performed by a processor, comprising:
receiving, by a software application, a request to perform an action at a local device;
determining, by the software application, that the requested action requires a license; and
accessing, by the software application, licensing information from an operating system-independent storage on the local device to determine if the requested action should be performed, wherein the operating system-independent storage is resident in a chipset associated with the processor.

12. The method of claim 11, wherein the act of accessing licensing information from an operating system-independent storage on the local device comprises accessing a portion of the operating system-independent storage that is allocated to the software application.

13. The method of claim 11, further comprising communicating with a remote device to obtain the licensing information.

14. The method of claim 13, wherein the act of communicating with a remote device to obtain the licensing information is performed when the local device is in a powered-down state.

15. The method of claim 11, wherein the act of accessing licensing information from an operating system-independent storage on the local device comprises calling, by the software application, a function provided in a third party library.

16. A device, comprising:
a memory; and
a processor having a storage in an associated chipset that is independent of an operating system of the device, wherein the processor is adapted to execute program code stored in the memory to:
receive a request to perform an action;
determine that the requested action requires a license; and
request data from the operating system-independent storage to determine if a valid license for the requested action exists.

17. The device of claim 16, wherein the program code to cause the processor to request data from the operating system-independent storage to determine if a valid license for the requested action exists comprises program code to cause the processor to perform an operation on the data.

18. A method, comprising:
storing, by a processor, licensing information for a software application and corresponding user information in a data store;
associating, by the processor, the licensing information with a device on which the software application is installed; and
writing, by the processor, the licensing information to an operating system-independent storage on the device, wherein the operating system-independent storage is resident in a chipset associated with a processor of the device.

19. The method of claim 18, wherein the act of writing the licensing information to an operating system-independent storage on the device comprises presenting write credentials to the device.

20. The method of claim 18, wherein the act of writing the licensing information to an operating system-independent storage comprises writing the licensing information using out of band communications over a network connection with the device when the device is in a powered down state.

21. The method of claim 18, wherein the act of writing the licensing information to an operating system-independent storage comprises writing the licensing information over a network connection with the device when an operating system of the device is inactive.

22. The method of claim 18, wherein the act of storing licensing information for a software application and corresponding user information in a data store comprises receiving the licensing information and the corresponding user information from a provider of the software application.
